(19) United States
(12) Patent Application Publication
(10) Pub. No.: US 2017/0009135 A1
(43) Pub. Date: Jan. 12, 2017

(54) COMPOSITE STRUCTURE BASED ON CE: YAG WAFER, AND MANUFACTURING METHOD THEREOF

(71) Applicant: KUNSHAN KAIWEI ELECTRONIC CO., LTD., Kunshan city, J i angsu (CN)

(72) Inventors: Dunhua CAO, Kunshan City (CN); Yueshan LIANG, Kunshan City (CN); Kejun MA, Kunshan City (CN)

(21) Appl. No.: 15/119,505

(22) PCT Filed: Jul. 9, 2014
(86) PCT No.: PCT/CN2014/081919

§ 371 Date: Aug. 17, 2016

(30) Foreign Application Priority Data
Feb. 27, 2014 (CN) 201410067883.8

(51) Int. Cl. C09K 11/77; G01T 1/202

(52) U.S. Cl. CPC C09K 11/7774; G01T 1/2023

(57) ABSTRACT

The invention discloses a composite structure based on a Ce:YAG wafer, comprising the Ce:YAG wafer and a red light emitting layer fixed on the Ce:YAG wafer. The invention further discloses a manufacturing method of the composite structure based on a Ce:YAG wafer, through which a composite optical structure capable of emitting light ranging from green light to red light is formed. The composite optical structure can be widely applied in the fields of detection equipment and illumination devices.

### FIELD OF THE INVENTION

The present invention relates to the field of optics, and particularly to a composite structure based on a Ce:YAG wafer and a manufacturing method thereof.

### BACKGROUND OF THE INVENTION

The cerium ion doped yttrium aluminum garnet (Ce:Y₃Al₅O₁₂ or Ce:YAG) crystal is a novel inorganic scintillation crystal appeared in the 1980s, and has a wide application prospect in the fields of high energy physics, nuclear physics, imaging nuclear medicine, industrial online detection, illumination and the like due to the advantages of higher light output, faster time decay constant and the like. Besides the higher light output (20,000 Ph/MeV) and faster time decay (88 ns/300 ns), the Ce:YAG scintillation crystal further has good capability of distinguishing γ rays from α particles with optical pulses, can emit 550 nm fluorescence which effectively couples with a silicon photodiode, can be excited by blue light having a wavelength within a range of 435 nm-470 nm and then combines with the blue light to form white light, and has excellent physical and chemical characteristics of a YAG matrix. Meanwhile, the Ce:YAG is suitable for growing into large-sized crystal, which can be cut and processed relatively simply and can be machined into wafers in various shapes, and thus has a quite wide application prospect.

The Ce:YAG wafer has numerous excellent properties. However, in some occasions in need of long wavelength based detection or illumination, the application of the Ce:YAG wafer has weaker effectiveness as the emission of the wafer has a main light emitting peak within the range of 525 nm-550 nm, a peak width of about 65-70 nm and relatively single wavelength.

### SUMMARY OF THE INVENTION

The technical problem to be solved by the present invention is to overcome the aforementioned defects in the prior art. By adding a red light emitting layer to the surface of a Ce:YAG wafer, a composite optical structure capable of emitting wide-band light ranging from green light to red light is formed.

The present invention provides a composite structure based on a Ce:YAG wafer, comprising a Ce:YAG wafer and a red light emitting layer fixed on the Ce:YAG wafer.

Preferably, the main light emitting peak of the red light emitting layer is within a range of 580 nm-660 nm.

Preferably, the red light emitting layer is a red light emitting film doped with fluorescent powder emitting red light.

Preferably, the red light emitting layer may also be a transparent colloid layer doped with fluorescent powder emitting red light.

Preferably, the red light emitting layer is a crystal, ceramic or glass doped with a red light emitting center.

To solve the above problem, the present invention further provides a manufacturing method of a composite structure based on a Ce:YAG wafer, including the following steps:

(1) producing a Ce:YAG wafer by a pulling method, temperature gradient method or kyropoulos method;

(2) cutting and polishing the Ce:YAG wafer produced by step (1) to obtain a fluorescent wafer with required size; and

(3) adding a red light emitting layer to the fluorescent wafer produced by step (2).

Preferably, the red light emitting layer in step (3) is a red light emitting film coated by physical or chemical vapor deposition method.

Preferably, the red light emitting layer in step (3) is a transparent colloid layer doped with fluorescent powder emitting red light.

Preferably, the red light emitting layer in step (3) is fixed on the fluorescent wafer, and is one of crystal, ceramic and glass doped with a red light emitting center of rare earth or transitional metal.

The light emission band of the Ce:YAG wafer of the present invention is within the range of 520 nm-600 nm, with the main peaks within the range of 525 nm-550 nm. The red light emitting layer selectively contains fluorescent powder which has a light emission band within the range of 580 nm-660 nm or has red light emitting ions directly doped in the matrix. The two bands superpose with each other to form a broad light emission peak, so that wide band light emission from green light to red light is realized, wherein the emission element in the selected red fluorescent powder in most cases is Eu, and the light decay time is on the millisecond level.

Compared with the prior art, the composite structure based on a Ce:YAG wafer and produced by the method of the present invention has the following advantages:

1) lower cost, more machining modes and simpler process; and

2) higher light yield, better time characteristic, wider emission spectra and better color effect.

### BRIEF DESCRIPTION OF THE DRAWINGS

FIG. 1 is a structural schematic diagram of an embodiment of the present invention;

FIG. 2 is an emission spectrum of a composite structure coated with a Eu:Y₂O₃ film in Embodiment 1;

FIG. 3 is an emission spectrum of a composite structure coated by way of gumming with a red fluorescent powder film in Embodiment 2;

FIG. 4 is an emission spectrum of a composite structure laminated with a Eu:YAG wafer by silica gel in Embodiment 3;

FIG. 5 is an emission spectrum of a composite structure in Embodiment 5;

FIG. 6 is an emission spectrum of a composite structure in Embodiment 6.

In the above drawings, reference number 1 represents Ce:YAG fluorescent wafer, and reference number 2 represents red light emitting layer.

### DETAILED DESCRIPTION OF THE EMBODIMENTS

The present invention will be further described in detail below in combination with the accompanying drawings and embodiments.

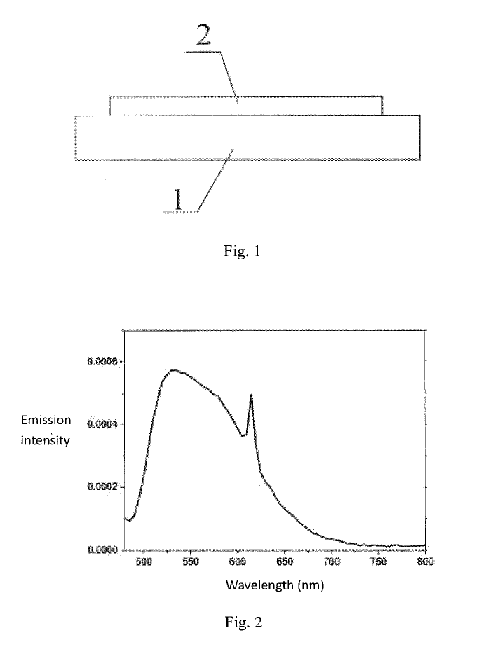

FIG. 1 is a schematic diagram of a composite structure based on a Ce:YAG wafer in an embodiment of the present invention. The composite structure comprises a Ce:YAG wafer 1 and a red light emitting layer 2 fixed on the Ce:YAG wafer 1.

### Embodiment 1

A Eu:Y₂O₃ film was coated by the sputtering method. Powdery Eu:Y₂O₃ was prepared first. The molar concentration of Eu ions is 0.2%. The powdery Eu:Y₂O₃ is then pressed into a bulk target. The Eu:Y₂O₃ target was attached to a cathode of a coating machine. A Ce:YAG wafer (the molar concentration of Ce ions is 0.3%) prepared by a pulling method is cut into the required size and polished. The Ce:YAG wafer was cleaned and then attached to an anode opposite to the target surface. The system was vacuumed to high vacuum (10⁻³ Pa) and then charged with 5 Pa argon.

Voltage was applied between the cathode and the anode to begin coating. Vacuuming operation was performed after coating, then nitrogen was charged for cold cutting, and a Ce:YAG wafer composite light emitting structure coated with a Eu:Y₂O₃ red light emitting film was finally obtained.

FIG. 2 is an emission spectrum of the composite structure coated with a Eu:Y₂O₃ film in Embodiment 1. It can be seen from the spectrum that the composite structure coated with a Eu:Y₂O₃ film has a emission spectra with the width of 500 nm-700 nm, and can realize emission ranging from green light to red light bands.

### Embodiment 2

A red fluorescent powder film was coated by way of gumming 0.05 wt % of red fluorescent powder is added into silica gel. The mixture was uniformly stirred and uniformly sprayed onto the surface of a Ce:YAG wafer (the molar concentration of Ce ions is 0.3%, and the Ce:YAG wafer is prepared by a temperature gradient method). Then the Ce:YAG wafer was braked for 3 hours at 120° C. A Ce:YAG wafer composite light emitting structure coated with a red fluorescent powder film was obtained after the gel is cured.

FIG. 3 is an emission spectrum of the composite structure coated by way of gumming with a red fluorescent powder film in Embodiment 2. It can be seen from the spectrum that the composite structure coated with the red fluorescent powder film has the emission spectra with the width of 500 nm-750 nm, and can realize the emission ranging from green light to red light.

### Embodiment 3

A Eu:YAG wafer (the molar concentration of Eu ions is 0.2%, and the Eu:YAG wafer is prepared by a kyropoulos method) was laminated with a Ce:YAG wafer (the molar concentration of Ce ions is 0.5%, and the Ce:YAG wafer is prepared by a temperature gradient method) by silica gel. The surfaces of the Ce:YAG wafer and the Eu:YAG wafer were polished, so that the wafers have good finish and planeness.

The surface of the Ce:YAG wafer was applied with silica gel and covered by the Eu:YAG wafer. The wafers were baked for 3 hours at 100° C. and then slowly cooled to room temperature to form a Ce:YAG and Eu:YAG wafer composite light emitting structure.

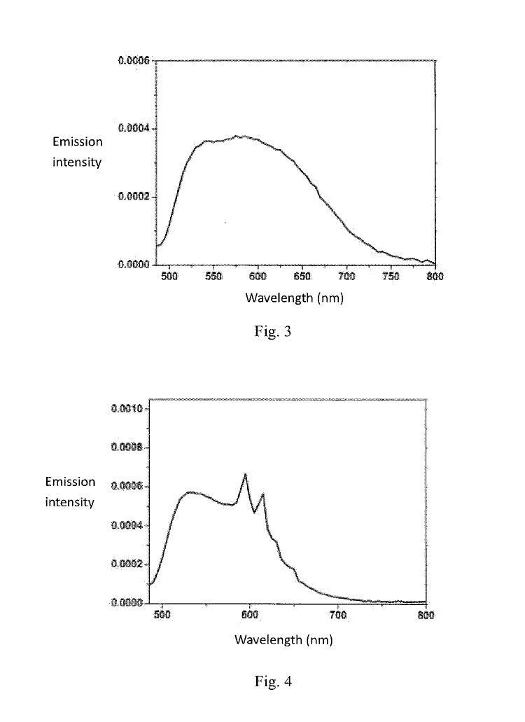

FIG. 4 is an emission spectrum of the composite structure laminated with the Eu:YAG wafer by silica gel in Embodiment 3. It can be seen from the spectrum that the composite structure laminated with a Eu:YAG wafer by silica gel has the emission spectra with the width of 500 nm-700 nm, and can realize the emission ranging from green light to red light.

### Embodiment 4

A Eu:YAG wafer (the molar concentration of Eu ions is 0.2%, and the Eu:YAG wafer is prepared by a kyropoulos method) was laminated with a Ce:YAG wafer (the molar concentration of Ce ions is 0.5%, and the Ce:YAG wafer is prepared by a temperature gradient method) by thermal bonding. The surfaces of the Ce:YAG wafer and the Eu:YAG wafer were polished, so that the wafers have good finish and planeness. The two polished surfaces were laminated together at room temperature, establishing a hydrogen bond connection via molecular films adsorbed on the surfaces to accomplish a room temperature optical gluing process. The wafers were then put into a hot-press device, heated to 1200° C. and kept at this temperature for 4 hours. Then the wafers were slowly cooled to room temperature to form a Ce:YAG and Eu:YAG wafer bonding structure.

### Embodiment 5

A certain amount of red fluorescent powder was weighed and added into low melting point glass powder. The red fluorescent powder accounts for 0.045% of the total weight. The red fluorescent powder and the glass powder were mixed uniformly.

Then the glass powder was covered onto a Ce:YAG wafer (the molar concentration of Ce ions is 0.5%, and the Ce:YAG wafer is prepared by a temperature gradient method). The wafer covered with the glass powder was then put into a sealed high temperature furnace, in which nitrogen was charged as a protective atmosphere having one barometric pressure. The wafer was heated to 400° C. at a temperature increasing rate of 200° C. per hour. The wafer was kept at the 400° C. for 20 minutes so that the glass powder was sufficiently melted and tightly laminated with the wafer.

Finally, the temperature dropped to room temperature at a temperature decreasing rate of 400° C. per hour to form a composite light emitting structure of the Ce:YAG wafer and the red light glass layer.

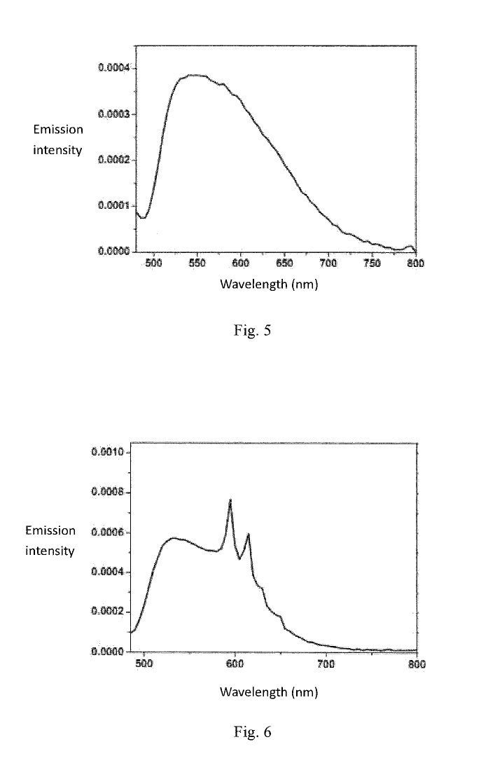

FIG. 5 is an emission spectrum of the composite structure in Embodiment 5. It can be seen from the spectrum that the composite structure has the emission spectra with the width of 500 nm-725 nm, and can realize emission ranging from green light to red light.

### Embodiment 6

A Eu:YAG transparent ceramic wafer (the concentration of Eu ions is 0.3%, and the ceramic wafer is outsourced) was laminated with a Ce:YAG wafer (the molar concentration of Ce ions is 0.5%, and the Ce:YAG wafer is prepared by a temperature gradient method) by silica gel. The surfaces of the Ce:YAG wafer and the Eu:YAG transparent ceramic wafer were polished, so that the wafers have good finish and planeness. The surface of the Ce:YAG wafer was applied with silica gel and covered by the Eu:YAG transparent ceramic wafer. The wafers were baked for 3 hours at 100° C. and then slowly cooled to room temperature to form a composite light emitting structure of the Ce:YAG wafer and the Eu:YAG transparent ceramic wafer.

FIG. 6 is an emission spectrum of the composite structure in Embodiment 6. It can be seen from the spectrum that the composite structure has the emission spectra with the width of 500 nm-700 nm, and realize emission ranging from green light to red light.

The above-mentioned specific embodiments further describe the purposes, technical solutions and beneficial effects of the invention in detail. It should be understood that the foregoing descriptions are merely specific embodiments of the invention, and the invention is not limited thereto. All modifications, equivalent substitutions, improvements and the like made within the spirit and principle of the invention shall fall into the protection scope of the invention.

1. A composite structure based on a Ce:YAG wafer, comprising a Ce:YAG wafer and a red light emitting layer fixed on the Ce:YAG wafer.

2. The composite structure based on a Ce:YAG wafer according to claim 1, wherein the main light emitting peak of the red light emitting layer is within a range of 580 nm-660 nm.

3. The composite structure based on a Ce:YAG wafer according to claim 2, wherein the red light emitting layer is a coated film layer emitting red light.

4. The composite structure based on a Ce:YAG wafer according to claim 2, wherein the red light emitting layer is a transparent colloid layer doped with fluorescent powder emitting red light.

5. The composite structure based on a Ce:YAG wafer according to claim 2, wherein the red light emitting layer is a crystal, ceramic or glass doped with a red light emitting center.

6. A manufacturing method of the composite structure based on a Ce:YAG wafer, comprising the following steps:
(1) producing a Ce:YAG wafer by a pulling method, temperature gradient method or kyropoulos method;
(2) cutting and polishing the Ce:YAG wafer produced in step (1) to obtain a fluorescent wafer with required size; and
(3) adding a red light emitting layer to the fluorescent wafer produced in step (2).

7. The manufacturing method of the composite structure based on a Ce:YAG wafer according to claim 6, wherein the red light emitting layer in step (3) is a red light emitting film coated by physical or chemical vapor deposition method.

8. The manufacturing method of the composite structure based on a Ce:YAG wafer according to claim 6, wherein the red light emitting layer in step (3) is a transparent colloid layer doped with fluorescent powder emitting red light.

9. The manufacturing method of the composite structure based on a Ce:YAG wafer according to claim 6, wherein the red light emitting layer in step (3) is fixed on the fluorescent wafer, and is one of a crystal, ceramic and glass doped with a red light emitting center of rare earth or transitional metal.
